(19) United States
(12) Patent Application Publication
(10) Pub. No.: US 2003/0037655 A1
(43) Pub. Date: Feb. 27, 2003

(54) Catch structure of rotary cover plate of circular sawing machine

(76) Inventor: Chang Chin-Chin, Taichung Hsien (TW)

Correspondence Address: CONNOLLY BOVE LODGE & HUTZ, LLP, 1220 N MARKET STREET, P O BOX 2207, WILMINGTON, DE, 19899

(21) Appl. No.: 09/934,011

(22) Filed: Aug. 21, 2001

(51) Int. Cl. B26D 5/00

(52) U.S. Cl. 83/397; 83/471.3; 83/477.1; 83/544; 83/698.11

(57) ABSTRACT

The present invention relates to a catch structure of a rotary cover plate of a circular sawing machine. A rotary cover plate is rotatably mounted on an upper blade guard of a circular sawing machine, to cover a semi-circular hole of the upper blade guard. A lower blade guard is pivoted on the rotary cover plate, so that the lower blade guard may be rotated relative to the rotary cover plate. The rotary cover plate has an inner side protruded with a first catch end which may be stopped and positioned on a side wall of the semi-circular hole. The rotary cover plate has an outer side protruded with a second catch end which may be stopped on a lug of a bottom edge of the lower blade guard.

### BACKGROUND OF THE INVENTION

1. Field of the Invention

The present invention relates to a catch structure of a rotary cover plate of a circular sawing machine, which may greatly increase the efficiency of assembly and maintenance of the circular sawing machine.

2. Description of the Related Art

A conventional circular sawing machine in accordance with the prior art is usually not provided with a lower blade guard structure, thereby easily causing danger to the operator during the cutting process of the circular sawing machine.

### SUMMARY OF THE INVENTION

The present invention has arisen to mitigate and/or obviate the disadvantage of the conventional circular sawing machine.

The primary objective of the present invention is to provide a catch structure of a rotary cover plate of a circular sawing machine that may increase the efficiency of assembly and maintenance of the circular sawing machine.

In accordance with the present invention, there is provided a catch structure of a rotary cover plate of a circular sawing machine, comprising: a rotary cover plate rotatably mounted on an outer side of an upper blade guard of a circular sawing machine, the rotary cover plate stopped and positioned on an outside of a substantially semi-circular hole of the upper blade guard to cover the substantially semi-circular hole of the upper blade guard, and a sector-shaped transparent lower blade guard oppositely pivoted on an outer side of the rotary cover plate, so that the sector-shaped transparent lower blade guard may be rotated relative to the rotary cover plate;

wherein, the rotary cover plate has an inner side protruded with a first catch end which may be moved with rotation of the rotary cover plate, to be stopped and positioned on a side wall of the semi-circular hole of the upper blade guard, and the rotary cover plate has an outer side protruded with a second catch end which may be oppositely stopped on a lug of a bottom edge of the sector-shaped transparent lower blade guard.

Further benefits and advantages of the present invention will become apparent after a careful reading of the detailed description with appropriate reference to the accompanying drawings.

### BRIEF DESCRIPTION OF THE DRAWINGS

FIG. 1 is a side pan view of a catch structure of a rotary cover plate of a circular sawing machine in accordance with the present invention;

FIG. 2 is a side pan view of a catch structure of a rotary cover plate of a circular sawing machine in accordance with the present invention, wherein the rotary cover plate is rotated;

FIG. 3 is a perspective view of a rotary cover plate in accordance with the present invention;

FIG. 4 is a cross-sectional view of the rotary cover plate taken along line 4-4 as shown in FIG. 3;

FIG. 5 is a front plan view of a lower blade guard in accordance with the present invention; and

FIG. 6 is a cross-sectional view taken along line 6-6 as shown in FIG. 22.

### DETAILED DESCRIPTION OF THE INVENTION

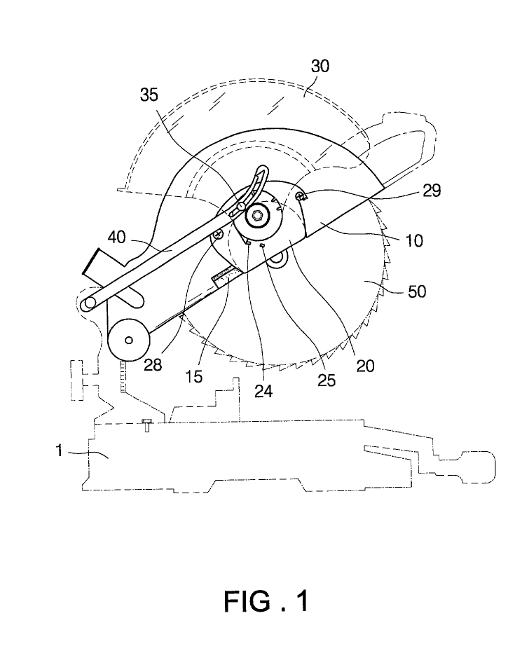

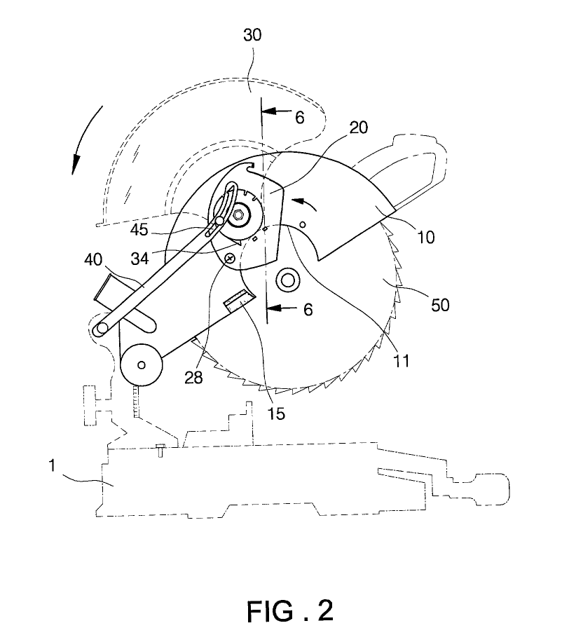

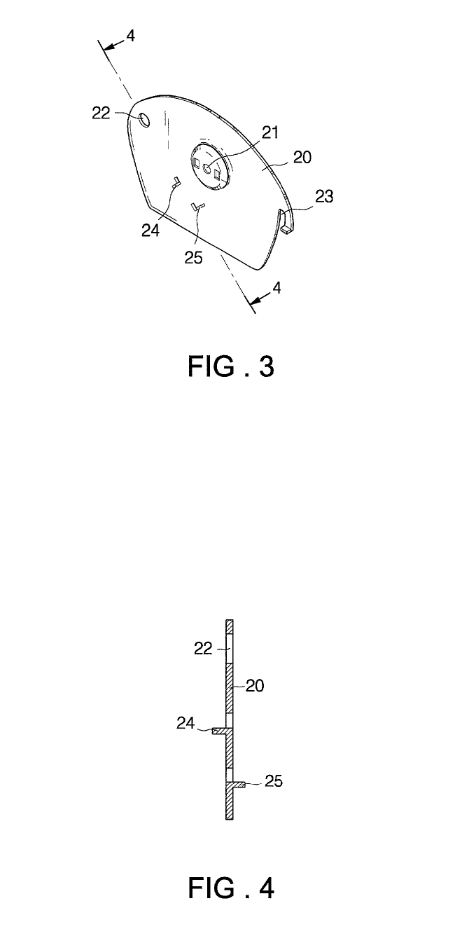

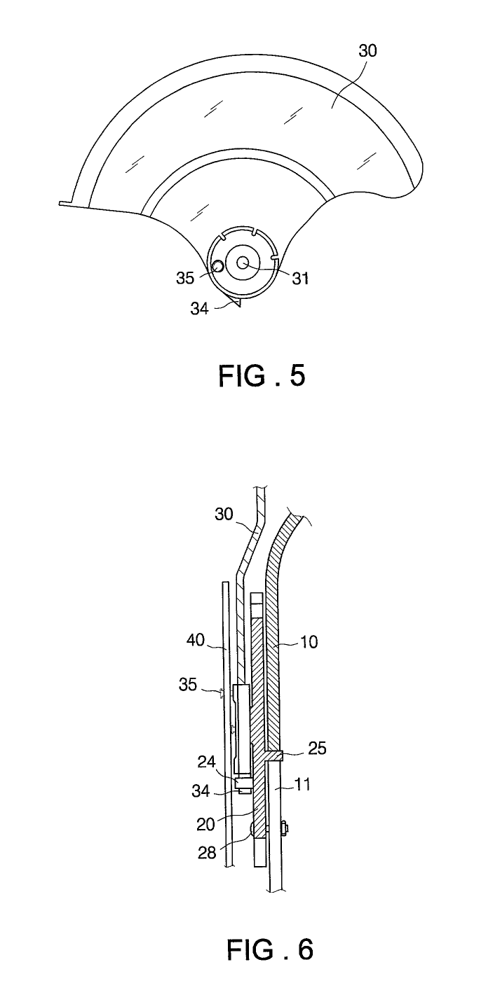

Referring to the drawings, a catch structure of a rotary cover plate of a circular sawing machine in accordance with the present invention is shown. A circular sawing machine has a frame seat 1 having a rear side having a top edge pivoted with an upper blade guard 10. The upper blade guard 10 has a side face formed with a substantially semi-circular hole 11 located adjacent the position of the center, thereby facilitating replacing a circular blade 50 that is mounted in the upper blade guard 10. A rotary cover plate 20 has a first end defining a pivot hole 22, such that the rotary cover plate 20 may be rotatably mounted on the upper blade guard 10 by a pin 28 as shown in FIG. 2. The rotary cover plate 20 has a second end defining a notch 23, such that the rotary cover plate 20 may be temporarily retained on the other end of the upper blade guard by a bolt 29 as shown in FIG. 1. The upper blade guard 10 is provided with a catch block 15 for stopping and positioning the bottom side of the rotary cover plate 20, so that the rotary cover plate 20 may be rotated clockwise about the pin 28, to cover the outside of the semi-circular hole 11 of the upper blade guard 10.

The rotary cover plate 20 has an inner side protruded with a catch end 25. When the rotary cover plate 20 is rotated upward counterclockwise, the catch end 25 may be moved with rotation of the rotary cover plate 20, to catch and abut the side wall of the semi-circular hole 11 of the upper blade guard 10 as shown in FIGS. 2 and 6, thereby preventing the rotary cover plate 20 from being rotated rearward excessively, and thereby preventing the rotary cover plate 20 from affecting the assembling work.

The included angle defined between the connecting line of the pin 28 and the catch end 25, and the horizontal line is much smaller than 90 degrees. Thus, when the user operates the sawing machine to move downward so as to perform a cutting motion in the clockwise direction, the rotary cover plate 20 is permanently subjected to an eccentrically downward gravity action, so that the rotary cover plate 20 may be rotated downward automatically into position, so as to entirely cover the outside of the semi-circular hole 11 of the upper blade guard 10, thereby efficiently enhancing safety of cutting the workpiece.

Relatively, the rotary cover plate 20 has an outer side protruded with a catch end 24 which may be oppositely stopped on a lug 34 of a bottom edge of a sector-shaped transparent lower blade guard 30, thereby preventing the transparent lower blade guard 30 from being rotated excessively when the transparent lower blade guard 30 is rotated upward counterclockwise by the user.

The bottom edge of the sector-shaped transparent lower blade guard has a shaft hole 31 aligning with the shaft hole 21 of the rotary cover plate 20, so that the sector-shaped transparent lower blade guard 30 may be rotated relative to the rotary cover plate 20.

A press bar 40 has a first end defining a guide slot 45 for passage of a protruding shaft 35 that is protruded outward from the bottom edge of the sector-shaped transparent lower blade guard 30. The press bar 40 has a second end pivoted on the top edge of the rear side of the frame seat 1, so that the press bar 40 mat be integrally moved with the sector-shaped transparent lower blade guard 30.

Accordingly, in the circular sawing machine of the present invention, the rotary cover plate 20 has an inner side protruded with a catch end 25. When the rotary cover plate 20 is rotated upward counterclockwise, the catch end 25 may be stopped and positioned by the side wall of the semi-circular hole 11 of the upper blade guard 10, thereby facilitating the user replacing, assembling or adjusting the circular blade 50, and thereby preventing the rotary cover plate from being rotated rearward excessively. Thus, the present invention may increase the efficiency of assembly and maintenance of the circular sawing machine.

In addition, the rotary cover plate 20 has an outer side protruded with a catch end 24 which may be oppositely stopped on the lug 34 of the bottom edge of the sector-shaped transparent lower blade guard 30, thereby preventing the lower blade guard 30 from being rotated excessively, and thereby preventing affecting the efficiency of the cutting work.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A catch structure of a rotary cover plate of a circular sawing machine, comprising: a rotary cover plate rotatably mounted on an outer side of an upper blade guard of a circular sawing machine, the rotary cover plate stopped and positioned on an outside of a substantially semi-circular hole of the upper blade guard to cover the substantially semi-circular hole of the upper blade guard, and a sector-shaped transparent lower blade guard oppositely pivoted on an outer side of the rotary cover plate, so that the sector-shaped transparent lower blade guard may be rotated relative to the rotary cover plate;
wherein, the rotary cover plate has an inner side protruded with a first catch end which may be moved with rotation of the rotary cover plate, to be stopped and positioned on a side wall of the semi-circular hole of the upper blade guard, and the rotary cover plate has an outer side protruded with a second catch end which may be oppositely stopped on a lug of a bottom edge of the sector-shaped transparent lower blade guard.

2. The catch structure of a rotary cover plate of a circular sawing machine in accordance with claim 1, wherein the upper blade guard is pivoted on a top edge of a rear side of a frame seat of the circular sawing machine.

3. The catch structure of a rotary cover plate of a circular sawing machine in accordance with claim 1, wherein the substantially semi-circular hole is formed on a side face of the upper blade guard and located adjacent a position of a center of the upper blade guard.

4. The catch structure of a rotary cover plate of a circular sawing machine in accordance with claim 1, wherein the rotary cover plate has a pivot hole provided with a pin, a connecting line is formed between the pin and the first catch end, an included angle is defined between the connecting line and a horizontal line, and is much smaller than 90 degrees, so that the rotary cover plate is permanently subjected to an eccentrically downward gravity action.

5. The catch structure of a rotary cover plate of a circular sawing machine in accordance with claim 1, further comprising a press bar defining a guide slot for passage of a protruding shaft that is protruded outward from a bottom edge of the sector-shaped transparent lower blade guard.
